(19) United States
(12) Patent Application Publication
(10) Pub. No.: US 2008/0156707 A1
(43) Pub. Date: Jul. 3, 2008

(54) MAGNETIC COUPLING FOR SHAKER MOTION WITHOUT MOTORS

(75) Inventor: Alan Wayne Burkhard, Fort Thomas, KY (US)

Correspondence Address: OSHA LIANG/MI, ONE HOUSTON CENTER, SUITE 2800, HOUSTON, TX, 77010, US

(73) Assignee: M-I LLC, Houston, TX (US)

(21) Appl. No.: 11/961,729

(22) Filed: Dec. 20, 2007

Related U.S. Application Data
(60) Provisional application No. 60/871,379, filed on Dec. 21, 2006.

(51) Int. Cl. B03B 4/02

(52) U.S. Cl. 209/564; 209/368

(57) ABSTRACT

Embodiments relate to a vibratory separator that includes a basket having a basket magnet and a frame having an electromagnet. The electromagnet and the basket magnet are arranged to magnetically interact, and the interaction imparts a vibratory motion to the basket. Furthermore, embodiments relate to a method to operate a vibratory separator that includes depositing drilling material on the vibratory separator. The vibratory separator includes a basket having a basket magnet, a frame having an electromagnet, and a variable frequency drive operatively coupled to the electromagnet. Furthermore, the method includes instructing the variable frequency drive to control the electromagnet and imparting a vibratory motion to the basket with the electromagnet.

### CROSS-REFERENCE TO RELATED APPLICATIONS

This application, pursuant to 35 U.S.C. § 119(e), claims priority to U.S. Provisional Application Ser. No. 60/871,379, filed Dec. 21, 2006. That application is incorporated by reference in its entirety.

### BACKGROUND OF THE DISCLOSURE

1. Field of the Disclosure

Generally, embodiments of the present disclosure relate to apparatuses and methods for separating solids from fluids. More specifically, embodiments of the present disclosure relate to apparatuses and methods for providing a vibratory motion to a vibratory shaker with electromagnets.

2. Background Art

Oilfield drilling fluid, often called “mud,” serves multiple purposes in the industry. Among its many functions, the drilling mud acts as a lubricant to cool rotary drill bits and facilitate faster cutting rates. Typically, the mud is mixed at the surface and pumped downhole at high pressure to the drill bit through a bore of the drillstring. Once the mud reaches the drill bit, it exits through various nozzles and ports where it lubricates and cools the drill bit. After exiting through the nozzles, the “spent” fluid returns to the surface through an annulus formed between the drillstring and the drilled wellbore.

Furthermore, drilling mud provides a column of hydrostatic pressure, or head, to prevent “blow out” of the well being drilled. This hydrostatic pressure offsets formation pressures thereby preventing fluids from blowing out if pressurized deposits in the formation are breeched. Two factors contributing to the hydrostatic pressure of the drilling mud column are the height (or depth) of the column (i.e., the vertical distance from the surface to the bottom of the wellbore) itself and the density (or its inverse, specific gravity) of the fluid used. Depending on the type and construction of the formation to be drilled, various weighting and lubrication agents are mixed into the drilling mud to obtain the right mixture. Typically, drilling mud weight is reported in “pounds,” short for pounds per gallon. Generally, increasing the amount of weighting agent solute dissolved in the mud base will create a heavier drilling mud. Drilling mud that is too light may not protect the formation from blow outs, and drilling mud that is too heavy may over invade the formation. Therefore, much time and consideration is spent to ensure the mud mixture is optimal. Because the mud evaluation and mixture process is time consuming and expensive, drillers and service companies prefer to reclaim the returned drilling mud and recycle it for continued use.

An additional purpose of the drilling mud is to carry the cuttings away from the drill bit at the bottom of the borehole to the surface. As a drill bit pulverizes or scrapes the rock formation at the bottom of the borehole, small pieces of solid material are left behind. The drilling fluid exiting the nozzles at the bit acts to stir-up and carry the solid particles of rock and formation to the surface within the annulus between the drillstring and the borehole. Therefore, the fluid exiting the borehole from the annulus is a slurry of formation cuttings in drilling mud. Before the mud can be recycled and re-pumped down through nozzles of the drill bit, the cutting particulates must be removed.

Apparatus in use today to remove cuttings and other solid particulates from drilling fluid are commonly referred to in the industry as “shale shakers.” A shale shaker, also known as a vibratory separator, is a vibrating sieve-like table upon which returning solids laden drilling fluid is deposited and through which clean drilling fluid emerges. Typically, the shale shaker is an angled table with a generally perforated filter screen bottom. Returning drilling fluid is deposited at the feed end of the shale shaker. As the drilling fluid travels down length of the vibrating table, the fluid falls through the perforations to a reservoir below leaving the solid particulate material behind. The vibrating action of the shale shaker table conveys solid particles left behind until they fall off the discharge end of the shaker table. The above described apparatus is illustrative of one type of shale shaker known to those of ordinary skill in the art. In alternate shale shakers, the top edge of the shaker may be relatively closer to the ground than the lower end. In such shale shakers, the angle of inclination may require the movement of particulates in a generally upward direction. In still other shale shakers, the table may not be angled, thus the vibrating action of the shaker alone may enable particle/fluid separation. Regardless, table inclination and/or design variations of existing shale shakers should not be considered a limitation of the present disclosure.

Preferably, the amount of vibration and the angle of inclination of the shale shaker table are adjustable to accommodate various drilling fluid flow rates and particulate percentages in the drilling fluid. After the fluid passes through the perforated bottom of the shale shaker, it can either return to service in the borehole immediately, be stored for measurement and evaluation, or pass through an additional piece of equipment (e.g., a drying shaker, centrifuge, or a smaller sized shale shaker) to farther remove smaller cuttings.

The vibratory motion of typical shakers is generated by one or more motors attached to the basket of the shaker. In such shakers, motors and actuation devices may be placed on or be integral to the basket. The location of the motors facilitates the transference of forces generated by the motors to the basket by allowing a motors shaft to couple to an actuator, which transfers motion to the basket. However, while placing motors and actuation devices on the frame and support members of the vibratory separator may facilitate the transference of forces to the basket, the motors also create stress points on the basket. Over time, the stress points caused by the basket mounted motors may result in structural failure of the basket. Such structural failure may require taking the shaker out of service, thereby resulting in expensive and time consuming repairs.

Furthermore, basket mounted motors complicate the replacement of critical shaker components, such as, for example, screen assemblies. In typical shakers with basket mounted motors, screens and/or screen assemblies are attached to the shaker underneath the motors, and thus the basket is heavy and screens may be difficult to reach during routine maintenance. Because of the location of the motors, routine maintenance, such as, for example, screen changes, may take substantial time. During screen changes the shaker is taken out of service, and in operations with only one screen, such routine maintenance may result in rig down time, thereby increasing net costs associated with the drilling operation.

Accordingly, there exists a need for a vibratory shaker with actuator devices for providing a vibratory motion to a screen assembly that may allow for faster screen changes, less structural failure, and a range of vibratory motions.

### SUMMARY OF THE DISCLOSURE

In one aspect, embodiments disclosed herein relate to a vibratory separator that includes a basket having a basket magnet and a frame having an electromagnet. The electromagnet and the basket magnet are arranged to magnetically interact, and the interaction imparts a vibratory motion to the basket.

In another aspect, embodiments disclosed herein relate to a method to operate a vibratory separator that includes depositing drilling material on the vibratory separator. The vibratory separator includes a basket having a basket magnet, a frame having an electromagnet, and a variable frequency drive operatively coupled to the electromagnet. Furthermore, the method includes instructing the variable frequency drive to control the electromagnet and imparting a vibratory motion to the basket with the electromagnet.

Other aspects and advantages of the disclosure will be apparent from the following description and the appended claims.

### BRIEF DESCRIPTION OF DRAWINGS

FIG. 1 shows a isometric view of a vibratory separator in accordance with an embodiment of the present disclosure.

FIG. 2 shows a side view of a vibratory separator in accordance with an embodiment of the present disclosure.

FIG. 3 shows a perspective view of a magnet holder in accordance with an embodiment of the present disclosure.

FIG. 4 shows a top view of a magnet holder in accordance with an embodiment of the present disclosure.

FIG. 5 shows a side view of a vibratory separator including a load shaft in accordance with an embodiment of the present disclosure.

FIG. 6 shows a side view of a vibratory separator in accordance with an embodiment of the present disclosure.

FIG. 7 shows a side view of a vibratory separator in accordance with an embodiment of the present disclosure.

FIG. 8 shows a side view of a vibratory separator including electromagnetic springs in accordance with an embodiment of the present disclosure.

FIG. 9 shows an end view of a vibratory separator in accordance with an embodiment of the present disclosure.

### DETAILED DESCRIPTION

Generally, embodiments of the present disclosure relate to apparatus and methods to separate solids from fluids. Specifically, embodiments of the present disclosure relate to apparatus and methods to provide a vibratory motion to a vibratory shaker with one or more electromagnets.

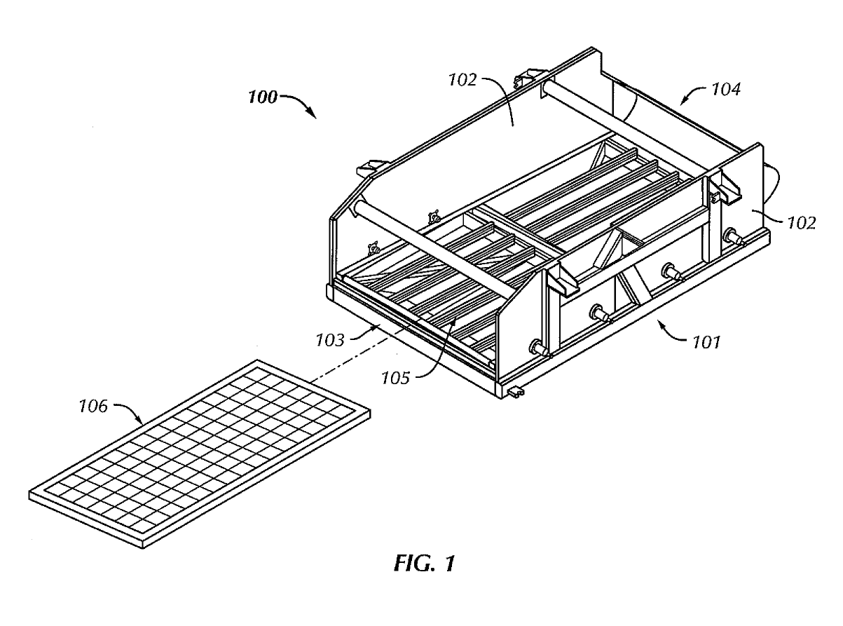

Referring initially to FIG. 1, a isometric view of a vibratory separator 100 in accordance with an embodiment of the present disclosure is shown. As illustrated, vibratory separator 100 includes a frame 101, sidewalls 102, a discharge end 103, and an inlet end 104. Vibratory separator 100 also includes a basket 105 that holds a screen assembly 106. Operationally, as drilling material enters vibratory separator 100 through inlet end 104, the drilling material is moved along screen assembly 106 by a vibratory motion. As screen assembly 106 vibrates, residual drilling fluid and particulate matter may fall through screen assembly 106 for collection and recycling, while larger solids are discharged from discharge end 103.

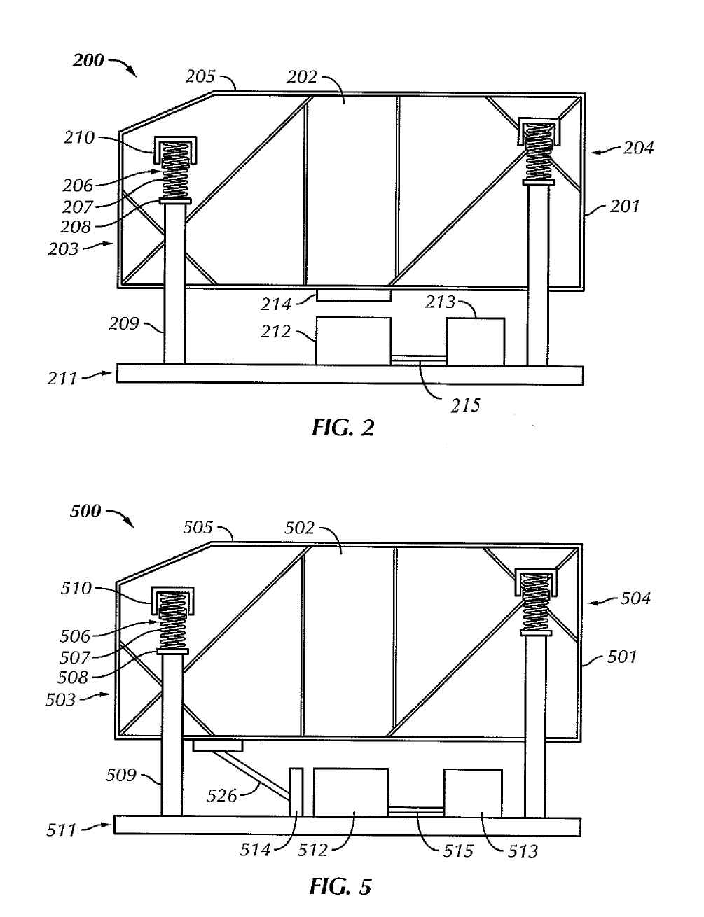

Referring to FIG. 2, a side view of a vibratory separator 200 in accordance with an embodiment of the present disclosure is shown. Corresponding to FIG. 1, vibratory separator 200 also includes a frame 201, sidewalls 202, a discharge end 203, an inlet end 204, and a basket 205. Vibratory separator 200 also includes a resilient mount system 206, wherein a spring 207 is mounted on a spring pad 208 that is attached to a leg 209. A socket 210 is coupled to vibratory separator 200 to receive spring 207 of resilient mount system 206. As such, basket 205 is supported by at least spring 207 so that as a vibratory motion is applied to basket 205 the motile range of basket 205 is constrained by resilient mount system 206.

Vibratory separator 200 is illustrated including a skid 211. Skid 211 forms a base on which legs 209, as well as vibratory motion components of vibratory separator 200, may be secured. In this embodiment, vibratory motion components include an electromagnet 212 and a variable frequency drive (“VFD”) 213. Electromagnet 212 is operatively coupled to VFD 213 via a control line 215, however, one of ordinary skill in the art will appreciate that in other embodiments, VFD 213 may be integral with electromagnet 212 thereby removing control line 215. Both electromagnet 212 and VFD 213 are illustrated secured to skid 211. Alternatively, electromagnet 212 and/or VFD 213 may be secured to any other component of vibratory separator 200, including, for example, one or more of legs 209, frame 201, and basket 205. In still other embodiments, electromagnet 212 and/or VFD 213 may be secured to a component that is not integral to vibratory separator 200, so long as at least electromagnet 212 may interact with a component of basket 205 to provide motion to the system.

In this embodiment, electromagnet 212 is disposed on skid 211, opposite a basket magnet 214, which is secured to basket 205. One of ordinary skill in the art will appreciate that the orientation of basket magnet 214 relative to electromagnet 212 may be varied, so long as a magnetic field produced by electromagnet 212 may interact with basket magnet 214. As such, basket magnet 214 may be located on basket 205, frame 201, one or more of legs 209, or any other component of vibratory separator 200, as long as basket magnet 214 is capable of interaction with electromagnet 212. Furthermore, one of ordinary skill in the art will appreciate that basket magnet 214 may be disposed on components not independently illustrated in the present disclosure, including, but not limited to, a pan, a possum belly, and/or a support member.

In one embodiment, basket magnet 214 may include one or more permanent magnets disposed in a magnet holder assembly. Referring to FIG. 3, a perspective view of a magnet holder assembly 320 in accordance with an embodiment of the present disclosure is shown. As illustrated, magnet holder assembly 320 includes a plurality of magnet holder slots 321 capable of housing one or more permanent magnets. Magnet holder assembly 320 also includes a shaft slot 322 capable of coupling magnet holder assembly 320 to a vibratory motion component, such as, for example, a load shaft 323 of a basket (not shown). In this embodiment, shaft slot 322 may extend through magnet holder assembly 320, thereby forming a protruding section 324 that may facilitate coupling. One of ordinary skill in the art will appreciate that in alternate embodiments, shaft slot 322 may include a recessed section to provide other means of connecting magnet holder assembly 320 to a component of a vibratory separator. Additionally, some embodiments of the present disclosure may not include magnet holder assembly 320, and magnets may be directly attached to a basket or other component of the vibratory separator.

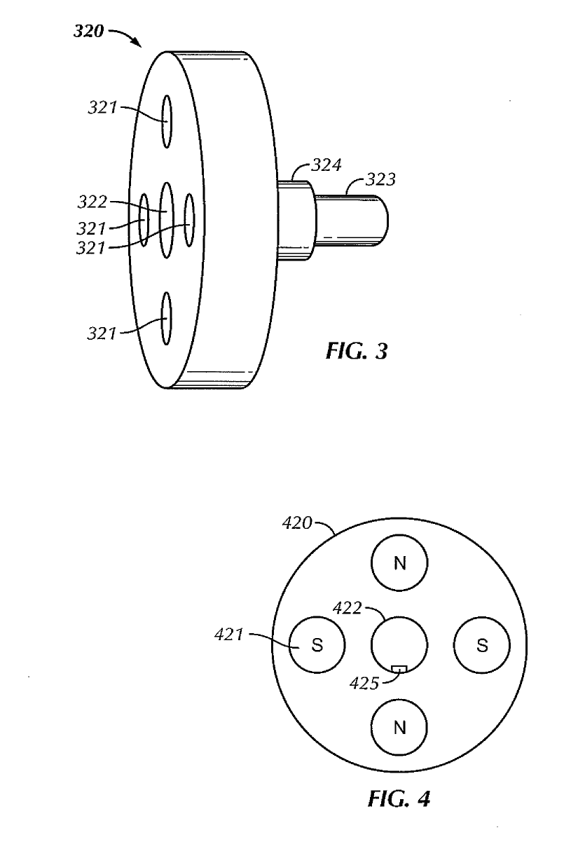

Referring to FIG. 4, a top view of a magnet holder assembly 420 in accordance with an embodiment of the present disclosure is shown. Magnet holder assembly 420 includes a plurality of magnet holder slots 421 with magnets disposed therein. As illustrated, magnets disposed in magnet holder slots 421 may include permanent magnets. In this embodiment, four permanent magnets are disposed in alternating states of polarity (e.g., north (“N”) or south (“S”)), and illustrated accordingly. One of ordinary skill in the art will appreciate that in alternate embodiments, the disposition of permanent magnets on the basket or in a magnet holder assembly 420 may include more than four magnets, less than four magnets, or the magnets may be arranged in a different pattern. Examples of such alternate patterns may include concentric orientation, radial orientation, orientation in square magnet holder slots 421, or any other placement and/or orientation of magnets as would be known to one of ordinary skill in the art.

In this embodiment, a load shaft, or other means of coupling magnet holder assembly 420 to the basket may slide into or otherwise couple with a shaft slot 422. Thus, shaft slot 422 may allow the attachment of magnets and/or magnet holder assembly 420 to a vibratory shaker. Additionally, in this embodiment, shaft slot 422 includes a grooved portion 425. Grooved portion 425 may provide a means for locking a load shaft to magnet holder assembly 420, or may otherwise provide a method of guiding the load shaft into correct orientation. In other embodiments, grooved portion 425 may facilitate securing magnet holding assembly 420 to the basket and/or vibratory separator.

As described regarding FIGS. 3 and 4, basket magnets may include permanent magnets. Permanent magnets may include any type of magnetic material known to one of ordinary skill in the art. Generally, permanent magnets used in accordance with embodiments disclosed herein include ferromagnetic material magnetized in one direction such that it will not revert back to zero magnetization when an imposed magnetizing field is removed. Such permanent magnets may be formed by casting the base materials, then grinding the cast into shape, or alternatively, may be mixed with resin binders then compressed and heat treated. Produced permanent magnets that may be used with embodiments disclosed herein may desirably have both high remanence and high coercivity. Examples of such magnets may include, for example, magnets formed from BaFe₁₂O₁₉, MnBi, and Ce(CuCo)₅. Examples of other such magnets that may me be used in embodiments disclosed herein include rare earth magnets, such as, for example, SmCo₅, Sm₂Co₁₇, and Nd₂Fe₁₄B. The above list is merely exemplary of permanent magnets that may be used in embodiments in accordance with the present disclosure. As such, one of ordinary skill in the art will appreciate that any magnets that may interact with electromagnets may be used as a basket magnet.

Additionally, the magnets in FIGS. 3 and 4 are illustrated arranged symmetrically around the magnet holder assembly. However, one of ordinary skill in the art will appreciate that other embodiments are anticipated wherein the magnets are arranged in, for example, a weighted configurations, an asymmetrical configuration, and/or in configurations wherein like pole magnets are adjacent. Other magnetic assemblies that may be used in accordance with embodiments of the present disclosure may include assemblies as disclosed in co-pending U.S. Provisional Application Ser. No. 60/871,222, titled Motors with Magnetic Coupling for Transfer of Shaker Motion, assigned to the assignee of the present application, filed on Dec. 21, 2006, and incorporated herein by reference in its entirety.

Moreover, basket magnets may be attached to a basket of a vibratory separator in accordance with embodiments of the present disclosure by coupling the magnets directly to the basket. In one embodiment, permanent magnets may be secured directly to a lower or sidewall section of the basket, while in other embodiments magnets may be secured to a load shaft that is operatively coupled to the basket.

Referring to FIG. 5, a vibratory separator 500 including a load shaft 526 in accordance with an embodiment of the present disclosure is shown. Vibratory separator 500 includes a frame 501, sidewalls 502, a discharge end 503, an inlet end 504, and a basket 505. Vibratory separator 500 also includes a resilient mount system 506, wherein a spring 507 is mounted on a spring pad 508 that is attached to a leg 509. A socket 510 is coupled to vibratory separator 500 to receive spring 507 of resilient mount system 506. As such, basket 505 is supported by at least spring 507 so that as a vibratory motion is applied to basket 505 the motile range of basket 505 is constrained by resilient mount system 506.

In this embodiment as electromagnet 512 interacts with basket magnet 514, a vibratory motion may be imparted to basket 505 through load shaft 526. Operatively, load shaft 526 moves according to the interaction of basket magnet 514 with electromagnet 512. Because load shaft 526 is coupled to basket 505, the motion from basket magnet 514 is transferred through load shaft 526 to basket 505. An embodiment including load shaft 526 may be desirable to impart a directional rotatable force to basket 505. Because load shaft 526 may attached between basket magnet 514 and basket 505 at an angle, the force vector applied to the basket as a result of the interaction of electromagnet 512 with basket magnet 514 may be varied.

In one embodiment, the angle of load shaft 526 may be varied either manually or via a control system to change a deck angle of basket 505. Additionally, in such an embodiment, a vibratory motion and/or a vibratory profiles, as are discussed below, may be varied by altering the load angle of attachment of load shaft 526 to basket 505. One of ordinary skill in the art will appreciate that in this embodiment, basket magnet 514 is not directly coupled to basket 505. Rather, basket magnet 514 is operatively coupled to basket 505 via load shaft 526. Thus, other configurations of vibratory separators 500 including basket magnets 514 indirectly coupled to basket 505 and/or basket magnets 514 operatively coupled to basket 505 are within the scope of the present disclosure.

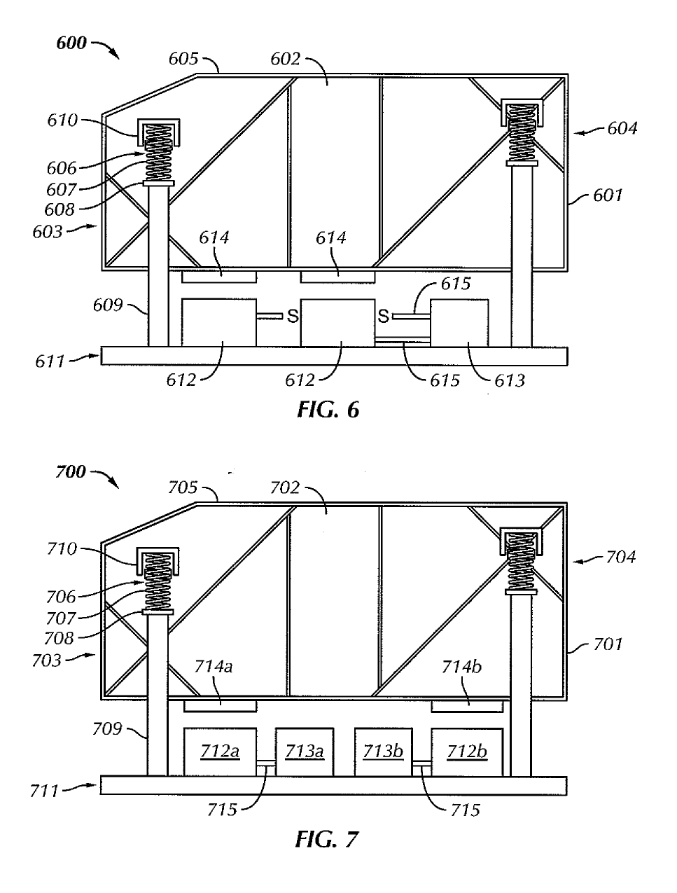

Referring now to FIG. 6, a vibratory separator 600 including multiple electromagnets in accordance with embodiments of the present disclosure is shown. In this embodiment, vibratory separator 600 includes a frame 601, sidewalls 602, a discharge end 603, an inlet end 604, and a basket 605. Vibratory separator 600 also includes a resilient mount system 606, wherein a spring 607 is mounted on a spring pad 608 that is attached to a leg 609. A socket 610 is coupled to vibratory separator 600 to receive spring 607 of resilient mount system 606. As such, basket 605 is supported by at least spring 607 so that as a vibratory motion is applied to basket 605 the motile range of basket 605 is constrained by resilient mount system 606.

In this embodiment, two electromagnets 612 are secured to skid 611, and two corresponding basket magnets 614 are secured to basket 605. Electromagnets 612 are connected to a VFD 613 via control lines 615. Thus, in this embodiment, a single set of instructions from VFD 613 may control both electromagnets 612. Such an embodiment may facilitate the impartation of similar vibratory motion and/or vibratory profiles for all of vibratory shaker 600.

However, in alternate embodiments, it may be desirable to impart multiple types of vibratory motion and/or vibratory profiles to basket 605 and/or vibratory separator 600. In such an embodiment, two or more electromagnets 612 and corresponding basket magnets 614 may be controlled by multiple VFDs 613.

Referring to FIG. 7, a vibratory separator 700 including a load shaft 715 in accordance with an embodiment of the present disclosure is shown. Vibratory separator 700 includes a frame 701, sidewalls 702, a discharge end 703, an inlet end 704, and a basket 705. Vibratory separator 700 also includes a resilient mount system 706, wherein a spring 707 is mounted on a spring pad 708 that is attached to a leg 709. A socket 710 is coupled to vibratory separator 700 to receive spring 707 of resilient mount system 706. As such, basket 705 is supported by at least spring 707 so that as a vibratory motion is applied to basket 705 the motile range of basket 705 is constrained by resilient mount system 706.

In this embodiment, a first VFD 713a may impart a first vibratory profile to electromagnet 712a, while a second VFD 713b imparts a second vibratory profile to electromagnet 712b. Thus, multiple types of motion may be imparted to a single basket 705. Such an arrangement may also allow for the net vibratory motion to be altered such that a complex vibration is generated, such as, for example, an elliptical motion. In such an embodiment, electromagnet 712a may impart a substantially linear repulsive force to basket 705 generating movement in a generally upward direction. In a corresponding manner, electromagnet 712b may generate a substantially linear attractive force to basket 705 generating movement in a generally downward direction. The net effect of such forces may result in a substantially elliptical motion being imparted to drilling material in basket 705. One of ordinary skill in the art will appreciate that other types of vibratory motion may be imparted to drilling material by changing the sequence of attractive and repulsive forces between multiple electromagnets 713 and basket magnets 714.

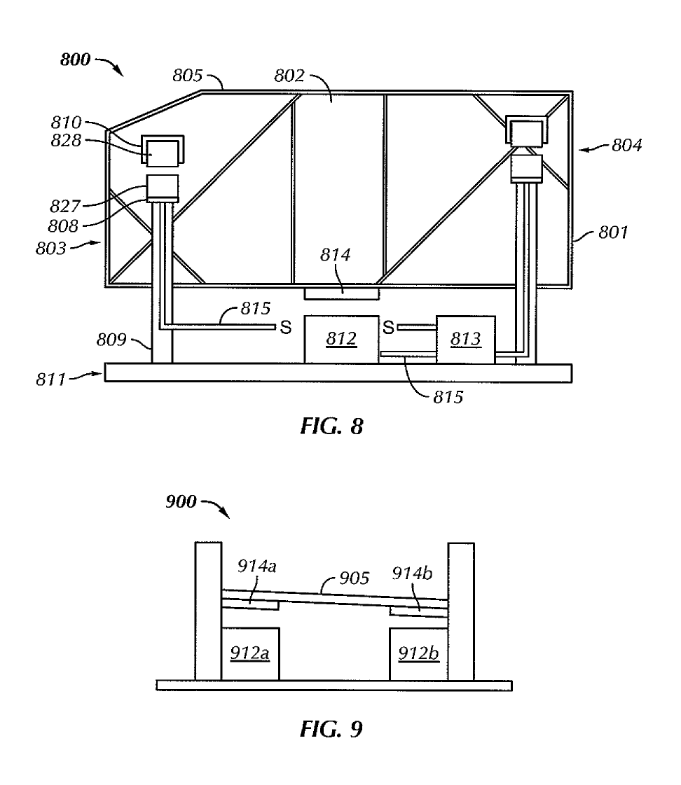

Referring now to FIG. 8, a vibratory separator 800 including electromagnetic springs in accordance with embodiments of the present disclosure is shown. In this embodiment, vibratory separator 800 includes a frame 801, sidewalls 802, a discharge end 803, an inlet end 804, and a basket 805. However, instead of a resilient mount system, as discussed above, vibratory separator 800 includes a magnetic spring system. In such an embodiment, a VFD 813 is connected to an electromagnet 812 disposed opposite a basket magnet 814, as described above. VFD 813 is also connected to one or more electromagnetic springs 827 disposed on spring pads 808. As illustrated, electromagnetic springs 827 are mounted on legs 809, just as springs would typically be mounted. However, opposite electromagnetic springs 827, located in a socket 810 are socket magnets 828.

In operation, VFD 813 may provide a current to electromagnetic springs 827 thereby causing repulsion between electromagnetic springs 827 and socket magnets 828. Thus, a gap may be formed between electromagnetic springs 827 and socket magnets 828, causing basket 805 to be raised. In such an embodiment, VFD 813 may then control a vibratory motion and/or vibratory profile by controlling electromagnets 812 and electromagnetic springs 828.

In one embodiment, VFD 813 may control electromagnet 812, thereby imparting a vibratory motion to basket 805, while merely controlling electromagnetic spring 828 as a levitation tool. In alternate embodiments, electromagnet 812 may impart a vibratory motion to basket 805, while electromagnetic spring also imparts a vibratory motion to basket 805. Thus, in at least one embodiment, electromagnet 812 and electromagnetic springs 828 may both impact a vibratory motion and/or vibratory profile imparted to vibratory separator 800.

One of ordinary skill in the art will appreciate that multiple VFD and multiple electromagnet systems may further provide vibratory motion and/or vibratory profiles in accordance with alternate embodiments described herein. Additional methods of using electromagnetic springs are disclosed in co-pending U.S. Provisional Application Ser. No. 60/871,215, titled Electromagnetic Separation for Shakers, assigned to the assignee of the present application, filed on Dec. 21, 2006, and incorporated herein by reference in its entirety.

Embodiments of the present disclosure described above include energizing and de-energizing at least one electromagnet system coupled to a vibratory shaker with at least one VFD. The electromagnet system may include at least one electromagnet coupled to a frame of a vibratory separator and at least one basket magnet coupled to a basket of the vibratory separator. Generally, electromagnets are a type of magnet in which a magnetic field is produced by a flow of electric current. Thus, when the current ceases, the generated magnetic field disappears.

Accordingly, different currents may be applied to electromagnets, such as, for example alternating currents (“AC currents”), direct currents (“DC currents”), and combinations thereof. In one embodiment, a DC current may be applied to an electromagnet such that the electromagnet repels the basket magnets. Thus, a steady repulsive force may be generated between electromagnets and basket magnets.

In alternate embodiments, an AC current may be applied to electromagnets. Thus, when an AC current is applied to the electromagnet, the poles of the electromagnet alternate as the current alternates. When such an AC current is applied, attractive forces may be generated between electromagnets and basket magnets for half of a cycle, and repulsive forces may be generated between electromagnets and basket magnets for the other half of the cycle. Over time, the alternating attractive and repulsive forces may impart a vibratory motion to the basket.

By varying such forces, the resultant force applied to the basket may be generated in a specified direction (e.g., in a vertical, horizontal, or angular direction). Furthermore, the vibratory motion may be imparted in addition to vibratory motion produced in other methods, such as, for example, by motors or secondary magnet systems (e.g., electromagnetic spring systems). Accordingly, one of ordinary skill in the art will appreciated that embodiments described herein may provide a primary or a second method of supplying vibratory motion and/or a vibratory profile to a vibratory shaker.

In other embodiments, a combination of DC and AC current may be applied to the electromagnets. The application of a DC current in addition to an AC current may cause additional magnetic flux in the core of the electromagnets. Such a bias may increase the magnetic force generated in one half of a cycle. Thus, an applied current may create more repulsive forces that attractive forces. Furthermore, the same current need not be applied to each of electromagnets. Rather, different currents may be applied to each electromagnet, thereby providing a desired type of vibratory motion. Moreover, those skilled in the art will appreciate that a current may be supplied by any current source known in the art, and will further appreciate that more than one current source may be used to supply current one electromagnet. As such, in one or more embodiments, a VFD may be used to supply, for example, an AC current.

Different vibratory profiles are known in the art that may be imparted on a basket of a vibratory separator by applying one or more currents to electromagnets located on a surface of the basket. For example, linear vibratory motions and elliptical vibratory motions may be imparted to the basket. In some embodiments, a controller, such as a programmable logic controller (“PLC”) may provide instructions to one or more current sources such as, for example, a VFD. Instructions provided by the PLC to a VFD may include vibratory motion protocols that define a pattern of movement for moving components of the vibratory separator. By controlling one or more current sources and applying one or more currents to electromagnets, a desired vibratory motion may be imparted to the basket. Specifically, as described above, AC or DC currents may be applied to electromagnets to impart a vibratory motion to the basket. Such currents may be applied individually, or they may be superimposed and applied to one or more of the electromagnets.

Additionally, the PLC may include instructions for varied separatory and/or vibratory profiles. In such an embodiment, the PLC may control the VFD, a secondary motors system, or both. Such PLC provided instructions may allow “on the fly” adjustment of motion types so that an operator may select an appropriate profile. By allowing a range of profiles, an operator may select a type of vibratory motion that provides an efficient separating of drill fluid from drill cuttings.

Additionally, programming instructions may be provided to allow a PLC to automatically adjust the type of force supplied according to a predetermined vibratory separator condition, such as, for example, a time interval and/or a sensed operating conditions. Thus, in one embodiment, a PLC may be included that determines and/or calculates operating conditions of a vibratory separator, and adjusts the separatory profile accordingly. In other embodiments, sensors may be included to determine load, so that the motor may self-adjust accordingly. For example, in a vibratory separator that includes a PLC controlling a VFD operatively coupled to an electromagnet, if the PLC sensed a high shaker load condition, the programmable logic controller may provide instructions to the VFD to turn off the current to the electromagnet. In other embodiments, a high load condition may cause the PLC to instruct the VFD to increase the current to the electromagnet to compensate for the high load condition.

In one embodiment, a single AC current may be continuously applied to the electromagnets to impart a steady vibratory motion to the basket. Additionally a VFD an AC current with any frequency such that a vibratory motion having a specified frequency is imparted to the basket. Furthermore, a plurality of VFDs may supply a plurality of AC currents such that a plurality of AC currents having different frequencies may be applied to the electromagnets. Such currents may be applied to one or more of the electromagnets in a staggered manner, or at certain time intervals, to impart a specified vibratory motion to the basket. Supplied currents may also vary in amplitude such that magnetic forces generated may be varied, thereby providing a desired vibratory motion.

In multiple electromagnet systems, the amplitudes of applied currents may vary such that a part of the basket may be substantially higher than a second part of the basket, as described above. For example, in a two electromagnet system a greater force may be applied to an outlet end of the basket than an inlet end. This embodiment may increase the time it takes for drilling material to move from the inlet end to the outlet end. Such an embodiment may result in a longer vibratory process, thereby providing drier cuttings and a greater recapture of fluids. Similarly, the inlet end may be raised to a greater height then outlet end, thereby decreasing the conveyance time the drilling material, and resulting in a faster vibratory process.

In another embodiment, basket magnets and electromagnets may be arranged so that a specified vibratory motion is imparted to the basket. For example, basket magnets on one side or end of the basket may be raised to a relatively higher state than respective basket magnets by increasing the current through opposing electromagnets accordingly. Thus, the basket may be substantially tilted in one direction.

Referring to FIG. 9, an end view of a vibratory separator 900 in accordance with an embodiment of the present disclosure is shown. In this embodiment, the magnetic forces between electromagnet 912a and basket magnet 914a and electromagnet 912b and basket magnet 914b are not equivalent. Thus, a greater gap exists between electromagnets 912 and corresponding basket magnets 914. Such a vibratory profile may provide additional vibratory motion shapes to drilling material processed by vibratory separator 900. A tilt of basket 905 may also occur by varying the current applied to electromagnets 912a and 912b non-equivalently. Thus, by supplying a greater current to electromagnet 912a than to electromagnet 912b, the gap between electromagnet 912a and basket magnet 914a may be relatively greater than the gap between electromagnet 912b and basket magnet 914b.

In one or more embodiments of the present disclosure, one or more control systems (e.g., PLCs) may be used to control certain aspects of the vibratory separator. Specifically, one or more control systems may be used to control the vibratory motion and/or vibratory profile of the vibratory separator. For example, a control system may monitor the position of the basket and control one or more current sources such that the basket is vibrated accordingly. Furthermore, the addition and removal of drilling material from a basket may cause fluctuations in the mass of the basket. A control system may control one or more currents of the system such that mass fluctuations may be accounted for. A control system may include, for example, position sensors and/or motion sensors to monitor the basket or other components of the vibratory separator.

Advantageously, embodiment disclosed herein may provide apparatus and methods to more efficiently separate drilling fluids and solids. The impartation of vibratory motion using magnetic forces may increase the shearing potential to drilling material thereby increasing the quality of processed drilling materials. Thus, by increasing the shearing potential of the vibratory separator, processing drilling fluid may result in dryer cuttings, and may result in increased drilling fluid recover. By producing dryer cuttings, the likelihood of environmental contamination may be decreased. Additionally, by increasing drilling fluid recovery, the net cost of a drilling operation may be decreased.

Moreover, by moving vibratory motion components from the basket to the vibratory shaker body, including the frame and the skid, stress points on the basket may be decreased and/or eliminated, and structural problems avoided. By increasing the structural integrity of at least one component of the vibratory shaker, costs associated with repairs, maintenance, and replacement of component costs may be decreased. Finally, by decreasing vibratory shaker down time, drilling operations may operate more quickly and efficiently.

While the present disclosure has been described with respect to a limited number of embodiments, those skilled in the hart, having benefit of this disclosure, will appreciate that other embodiments may be devised which do not depart form the scope of the present disclosure as described herein. Accordingly, the scope of the present disclosure should be limited only by the attached claims.

What is claimed is:

1. A vibratory separator, comprising:
a basket comprising a basket magnet; and
a frame comprising an electromagnet;
wherein the electromagnet and the basket magnet are arranged to magnetically interact; and
wherein the interaction imparts a vibratory motion to the basket.

2. The vibratory separator of claim 1, further comprising:
a variable frequency drive operatively coupled to the electromagnet.

3. The vibratory separator of claim 2, wherein the variable frequency drive is disposed on the frame.

4. The vibratory separator of claim 2, further comprising:
a programmable logic controller operatively coupled to the variable frequency drive.

5. The vibratory separator of claim 4, wherein the programmable logic controller instructs the variable frequency drive to control the electromagnet according to a vibratory profile.

6. The vibratory separator of claim 5, wherein the vibratory profile defines the vibratory motion imparted to the basket.

7. The vibratory separator of claim 6, wherein the vibratory profile defines a time sequence for operating the vibratory separator.

8. The vibratory separator of claim 4, wherein the programmable logic controller instructs the electromagnets to turn off if a specified shaker load is exceeded.

9. The vibratory separator of claim 1, wherein the vibratory motion comprises at least one of linear motion, elliptical motion, and round motion.

10. The vibratory separator of claim 1, wherein the frame comprises a skid.

11. The vibratory separator of claim 1, wherein the basket magnet comprises a permanent magnet.

12. The vibratory separator of claim 1, wherein the basket magnet comprises a rare earth magnet.

13. The vibratory separator of claim 1 wherein the interaction comprises energizing and de-energizing the electromagnet.

14. The vibratory separator of claim 1, wherein the basket magnet comprises an electromagnet.

15. A method to operate a vibratory separator, comprising:
depositing drilling material on the vibratory separator, the vibratory separator comprising:
a basket comprising a basket magnet;
a frame comprising an electromagnet; and
a variable frequency drive operatively coupled to the electromagnet;
instructing the variable frequency drive to control the electromagnet; and
imparting a vibratory motion to the basket with the electromagnet.

16. The method of claim 15, wherein the instructing is performed by a programmable logic controller.

17. The method of claim 16, wherein the instructing defines a vibratory profile.

18. The method of claim 15, wherein the vibratory motion comprises at least one of linear motion, elliptical motion, and round motion.

19. The method of claim 19, wherein the vibratory profile defines a time sequence for energizing and de-energizing the electromagnet.

20. A method to operate the vibratory separator of claim 1, comprising:
depositing drilling material on the vibratory separator; and
imparting a vibratory motion to a basket of the vibratory separator with an electromagnet.
